(19) United States
(12) Patent Application Publication
(10) Pub. No.: US 2013/0329623 A1
(43) Pub. Date: Dec. 12, 2013

(54) METHOD AND APPARATUS FOR REFERENCE SYMBOL CONFIGURATION

(71) Applicant: RENESAS MOBILE CORPORATION, Tokyo (JP)

(72) Inventors: Timo Kalevi Koskela, Oulu (FI); Karl Marko Juhani Lampinen, Oulu (FI); Sami-Jukka Hakola, Kempele (FI); Samuli Turtinen, Ii (FI); Jukka Talvitie, Tampere (FI); Toni Levanen, Tampere (FI)

(21) Appl. No.: 13/910,500

(22) Filed: Jun. 5, 2013

(30) Foreign Application Priority Data
Jun. 6, 2012 (GB) 1210002.0

(51) Int. Cl. H04W 72/04

(52) U.S. Cl. CPC H04W 72/0453
USPC 370/312; 370/329

(57) ABSTRACT

A method, apparatus, and computer program product are provided to provide configurations for transmitting reference symbols in a wireless communication network. In the context of a method, a first set of one or more reference symbols may be caused to be transmitted by a first access point in at least one control channel of a system frame comprising a plurality of control channels and incorporating control channel frequency reuse. The reference symbols of the first set may overlap with at least one reference symbol in a second set of one or more reference symbols transmitted by a second access point. Multiple configurations for the reference symbols may also be provided, including a minimum configuration.

### CROSS REFERENCE TO RELATED APPLICATION

This application claims the benefit under 35 U.S.C. §119(a) and 37 CFR §1.55 to UK patent application no. 1210002.0, filed on Jun. 6, 2012, the entire content of which is incorporated herein by reference.

### TECHNICAL FIELD

An example embodiment of the present invention relates generally to wireless networks and, more particularly, to configurations for transmitting reference symbols.

### BACKGROUND

In frame based orthogonal frequency-division multiplexed (OFDM) wireless communication networks, reference signals may be used for access point detection, synchronization and/or channel estimation. Access points may utilize a specific reference sequence chosen from an orthogonal set of sequences. The sequence set design may be dependent on the deployment scenario because reference symbol spacing in the time-frequency domain should be sufficient to have reliable channel estimates required for coherent transmission.

Some OFDM systems may utilize a technique called frequency reuse, in which the same frequency is reused by access points within the network. In some OFDM systems, control channel frequency reuse may be utilized. In an OFDM system using control channel frequency reuse, control regions of different access points may be separated in the frequency domain while the data channel bandwidth is shared with a frequency reuse factor of 1, meaning the entire data channel bandwidth can be reused by each access point. It is currently unclear how reference symbols can be configured in such a system, especially in a way that is flexible and allows for reliable reception in various deployment scenarios.

### SUMMARY

Therefore, a method, apparatus, and computer program product are provided according to an example embodiment in order to configure reference symbols in a wireless communication system utilizing control channel frequency reuse. In this regard, the method, apparatus, computer program product, and system may provide for a reference symbol configuration in which reference symbol locations of different access points overlap within their respective control regions. The various embodiments thus provide efficient and flexible reference symbol configurations that may be adapted to various deployment scenarios.

In a first exemplary embodiment of the invention, an apparatus is provided that includes at least one processor and at least one memory storing program code instruction therein, the at least one memory and program code instructions being configured to, with the at least one processor, cause the apparatus to at least cause a first set of one or more reference symbols to be transmitted in at least a first control channel of a system frame by a first access point, the system frame comprising a plurality of control channels and incorporating control channel frequency reuse. At least one of the reference symbols of the first set overlaps with at least one reference symbol in a second set of one or more reference symbols transmitted by a second access point. The second access point is configured to use a second, different, control channel, the second control channel occupying a different portion of the frequency domain from that occupied by the first control channel.

In a second exemplary embodiment of the invention, a method is provided that includes causing a first set of one or more reference symbols to be transmitted in at least a first control channel of a system frame by a first access point, the system frame comprising a plurality of control channels and incorporating control channel frequency reuse. At least one of the reference symbols of the first set overlaps with at least one reference symbol in a second set of one or more reference symbols transmitted by a second access point. The second access point is configured to use a second, different, control channel, the second control channel occupying a different portion of the frequency domain from that occupied by the first control channel.

In a third exemplary embodiment of the invention, a computer program product is provided that includes a non-transitory computer readable medium storing computer program code portions therein, the computer program code portions being configured to, upon execution, cause a first set of one or more reference symbols to be transmitted in at least a first control channel of a system frame by a first access point, the system frame comprising a plurality of control channels and incorporating control channel frequency reuse. At least one of the reference symbols of the first set overlaps with at least one reference symbol in a second set of one or more reference symbols transmitted by a second access point. The second access point is configured to use a second, different, control channel, the second control channel occupying a different portion of the frequency domain from that occupied by the first control channel.

In a fourth exemplary embodiment of the invention, an apparatus is provided that includes means for causing a first set of one or more reference symbols to be transmitted in at least a first control channel of a system frame by a first access point, the system frame comprising a plurality of control channels and incorporating control channel frequency reuse, and at least one of the reference symbols of the first set overlapping with at least one reference symbol in a second set of one or more reference symbols transmitted by a second access point. The second access point is configured to use a second, different, control channel, the second control channel occupying a different portion of the frequency domain from that occupied by the first control channel.

In a fifth exemplary embodiment of the invention, a system is provided that includes a first access point and a second access point. The first access point is arranged to cause a first set of one or more reference symbols to be transmitted in at least a first control channel of a system frame, the system frame comprising a plurality of control channels and incorporating control channel frequency reuse. The second access point is arranged to cause a second set of one or more reference symbols to be transmitted in at least a second control channel of the system frame. At least one of the reference symbols of the first set overlaps with at least one reference symbol of the second set.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is an illustration of a system that may operate in accordance with an example embodiment of the present invention;

FIG. 2 is a block diagram of an apparatus that may be configured in accordance with an example embodiment of the present invention;

FIG. 3 is a diagram depicting a prior art Long Term Evolution (LTE) Cell-specific Reference Symbol (CRS) arrangement in the case of a single antenna port access point;

FIG. 4 is a diagram depicting the concept of control channel frequency reuse;

FIG. 5 is a diagram depicting an example reference symbol configuration in a system utilizing control channel frequency reuse;

FIG. 6 is a diagram depicting an example reference symbol configuration according to an embodiment of the present invention from the perspective of access point A; and

FIG. 7 is a diagram depicting an example reference symbol configuration according to an embodiment of the present invention from the perspective of access point B; and

FIG. 8 is a diagram depicting another example reference symbol configuration according to an embodiment of the present invention.

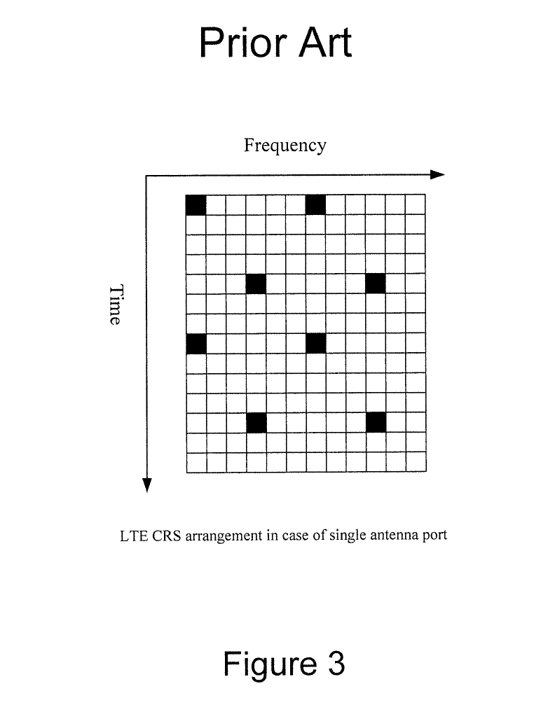

Note that the x (horizontal) axis represents frequency and the y (vertical) axis represents time in FIGS. 3-8.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

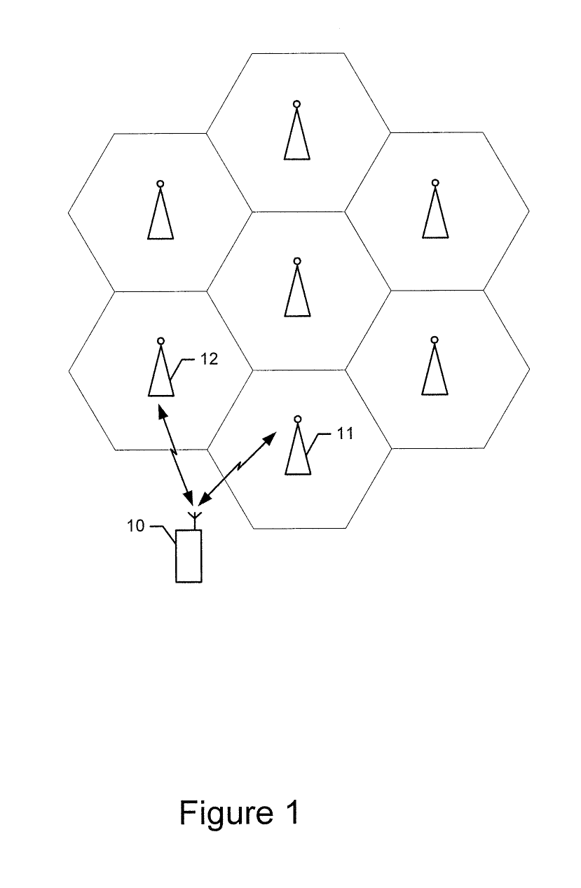

Referring now to FIG. 1, a system that supports communications between a user equipment 10 and a network, such as a Universal Mobile Telecommunications System (UMTS) network, a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a Frequency-Division Multiplexing (FDM) network, e.g., an Orthogonal Frequency-Division Multiplexing (OFDM) network, a General Packet Radio Service (GPRS) network or other type of network, via one or more access points 11, 12 is shown. As used herein, an access point refers to any communication device which provides connectivity to a network, such as a base station, an access node, or any equivalent, such as a Node B, an evolved Node B (eNB), a relay node, or other type of access point. The term “user equipment” includes any mobile communication device such as, for example, a mobile telephone, portable digital assistant (PDA), pager, laptop computer, a tablet computer, or any of numerous other hand held or portable communication devices, computation devices, content generation devices, content consumption devices, data card, Universal Serial Bus (USB) dongle, or combinations thereof. The communications between the user equipment 10 and the base station 12 may include the transmission of data via an uplink that is granted between the user equipment 10 and access point 11 and/or 12. The communication session between the user equipment 10 and the base station 12 may involve communication of data arranged in system frames and the communication session may be configured according to system information broadcast by access points 11 and/or 12 and received and read by user equipment 10. Access points 11 and 12 may, for example, belong to different network operators.

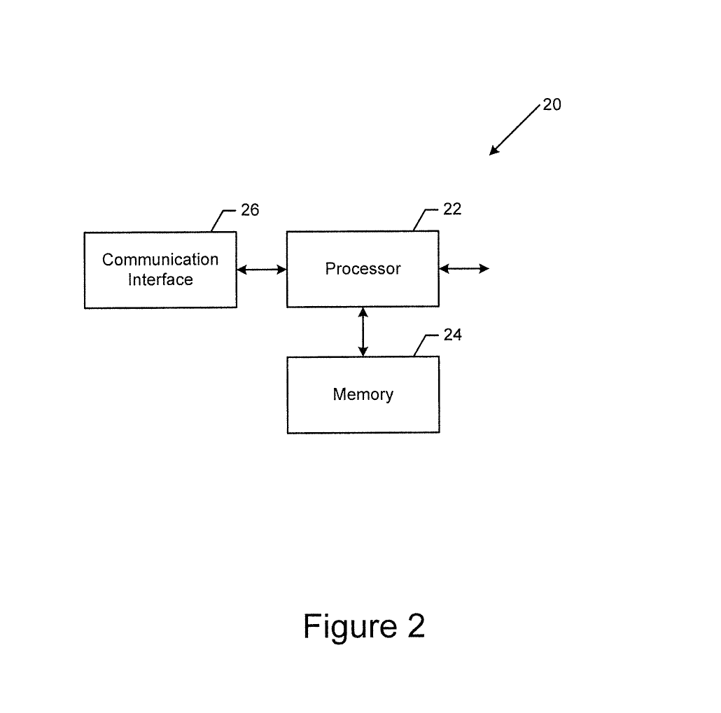

The access points 11, 12 may embody or otherwise be associated with an apparatus 20 that is generally depicted in FIG. 2 and that may be configured in accordance with an example embodiment of the present invention as described below. However, it should be noted that the components, devices or elements described below may not be mandatory and thus some may be omitted in certain embodiments. Additionally, some embodiments may include further or different components, devices or elements beyond those shown and described herein.

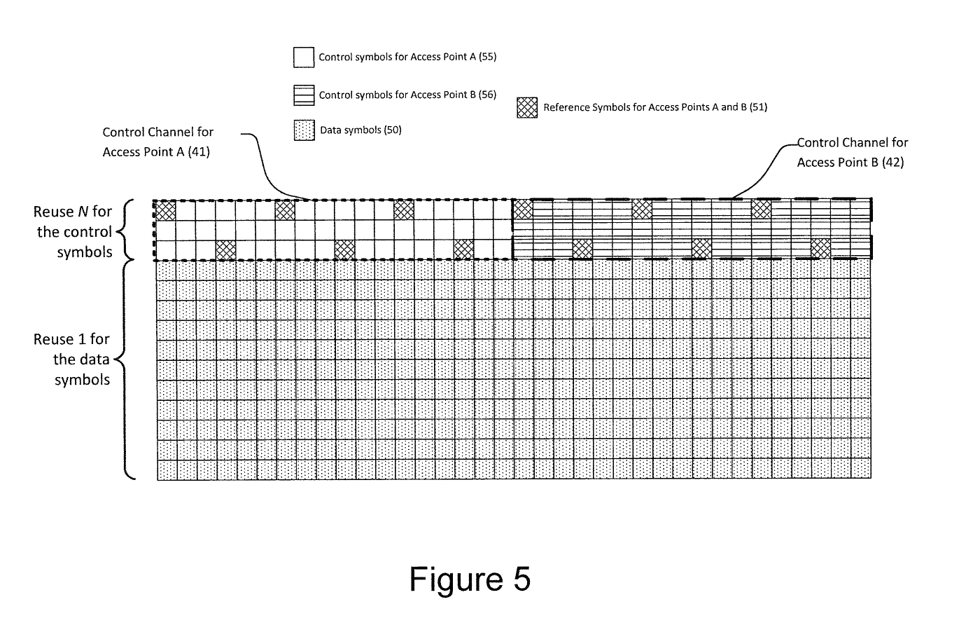

As shown in FIG. 2, the apparatus 20 may include or otherwise be in communication with processing circuitry, such as the processor 20 and, in some embodiments, the memory 24, which is configurable to perform actions in accordance with example embodiments described herein, such as in conjunction with FIGS. 5, 6, and 7. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry may include a processor 22 and memory 24 that may be in communication with or otherwise control a communication interface 26. As such, the processing circuitry may be embodied as a circuit chip (e.g., an integrated circuit chip) configured (e.g., with hardware, software or a combination of hardware and software) to perform operations described herein. However, in some embodiments taken in the context of access points 11 or 12, the processing circuitry may be embodied as a portion of the access point.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network and/or any other device or module in communication with the processing circuitry, such as between the user equipment (UE) 10 and access points 11 and 12. In this regard, the communication interface may include, for example, an antenna (or multiple antennas), such as an antenna (or multiple antennas) capable of communicating over radio frequencies (RF), and supporting hardware and/or software, such as RF circuitry, for enabling communications with a wireless communication network. The communication interface 26 may also or alternatively include a communication modem or other hardware/software for supporting communication via cable, digital subscriber line (DSL), universal serial bus (USB), Ethernet or other methods.

In an example embodiment, the memory 24 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 22. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 22 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), DSP (digital signal processor), or the like. In an example embodiment, the processor may be configured to execute instructions stored in the memory 24 or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA, DSP or the like, the processor may be specifically configured hardware for conducting the operations described herein. Alternatively, as another example, when the processor is embodied as an executor of software instructions, the instructions may specifically configure the processor to perform the operations described herein.

As discussed in the Background, certain wireless communication systems may use reference signals for access point detection, synchronization, and/or channel estimation. Each access point utilizes a specific reference sequence allowing access point detection to be done by correlating the received signal with the desired cell specific reference sequence. From here, time and frequency synchronization can be achieved by using the same correlation function and adjusting timing and frequency offsets to match with the known reference signal. Reference symbol configurations are preferably deployment specific. For example, the configurations may depend on the antenna configuration of a given access point. An example of the configuration of cell specific reference symbols (CRSs) in an LTE system in the case of a single antenna port is depicted in FIG. 3. The grid represents resources of a system frame in the frequency-time domain and each black square represents a reference symbol. To provide spacing between the CRSs of different cells, the CRSs of each cell can be frequency shifted based on the cell ID. For example, 3GPP TS 36.211 provides that the cell-specific frequency shift (v_{shift}) is defined as ^{v}^{_{shift}}^{=N}^{_{ID}}^{cell} ^{_{mod 6}}.

The LTE-A system (LTE rel'10) in TS36.211 defines another set of downlink common reference signals (CSI-RS) where each cell may have certain pattern. In addition, zero power patterns of the same CSI-RS pattern can also be defined creating a code division system among cells for the CSI-RS symbols. Here the code matrix would be an identity matrix instead of a hadamard matrix, typically used in CDMA systems. Furthermore, the pattern construction is such that patterns for higher numbers of antennas can be combined from the patterns used for lower numbers of antennas. The density of the pattern always remains the same per antenna port.

Control of control channel interference is discussed between macro and home eNodeBs in U.S.20110170496 by allocating a portion of the control channels for specific cells, but the coordination of reference signals is not discussed.

Certain wireless communication systems may also utilize a technique called frequency reuse. Frequency reuse divides system bandwidth into a finite number (the “reuse factor” in the notation adopted herein) of frequency sub-bands, or “channels,” which are reused amongst cells, each cell having at least one associated access point. Thus, if the system depicted in FIG. 1 were to utilize a frequency reuse factor of 7, each of the cells could utilize a different channel. If, instead, the frequency reuse factor were 6, one of the cells would use the same channel as one other cell, and so forth.

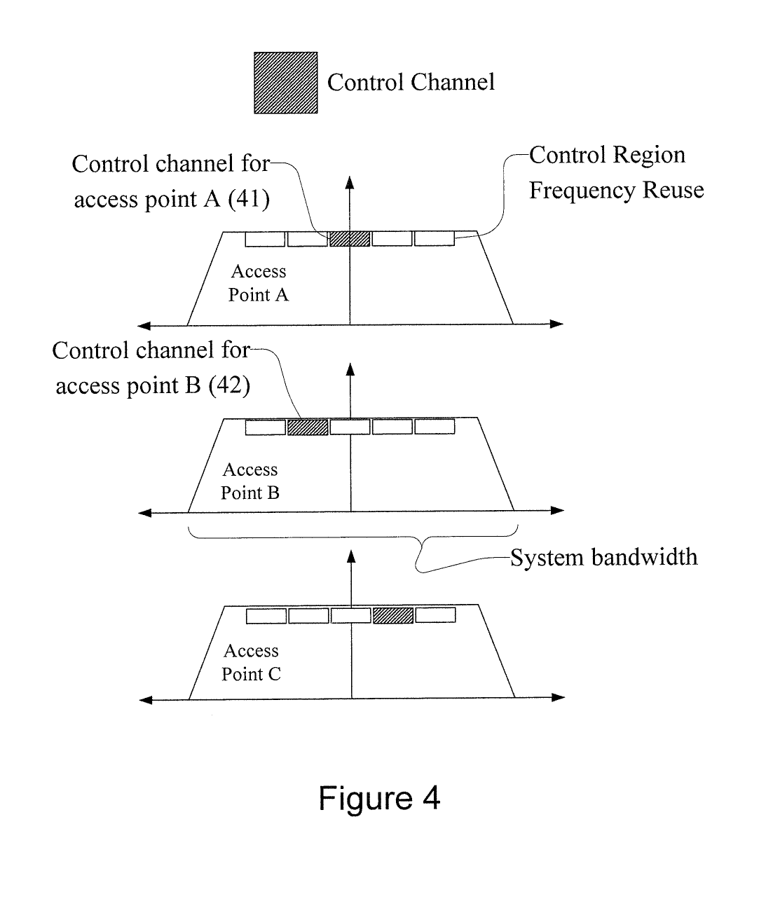

The frequency reuse technique may be implemented in the control region. Thus, for example, the control regions of different access points associated with different cells may be separated in the frequency domain. A diagram of the bandwidth for such a system with reuse factor of five for the control region is illustrated in FIG. 4. As shown, the control region is divided into 5 discrete channels in the frequency domain. Thus, the control channel 41 for access point A, such as access point 11 depicted in FIG. 1, occupies a different portion of the system bandwidth in the frequency domain than the control channel 42 for access point B, such as access point 12 depicted in FIG. 1.

A system is thus provided according to embodiments of the present invention, for utilizing control region frequency reuse, e.g., with a reuse factor greater than 1, and sharing data channel bandwidth with frequency reuse of 1. In other words, according to an example embodiment, the data channel may be shared amongst two or more cells/access points, while the control region is divided into two or more discrete control channels with a control region frequency reuse factor of N>1. In this manner, the control transmissions may be protected with FDMA, while the data transmissions are not. An example of a system frame composed of subcarriers (represented as blocks) and transmitted in such a system is depicted in FIG. 5. As shown, a reuse factor of N is utilized for the control region, while a reuse factor of 1 is used for the data region. Thus, access point A, such as access point 11 in FIG. 1, may use control channel 41 to transmit control data, such as control symbols 55, while access point B, such as access point 12 in FIG. 2, may use control channel 42 to transmit control data, such as control symbols 55. Data symbols 50 may, according to one embodiment, be transmitted by either or both access points throughout the entire system bandwidth.

According to an additional aspect of an example embodiment, and as further depicted in FIG. 5, reference symbols for access points A and B may overlap with one another. Thus, while control data transmissions, such as control symbols 55 and 56, are frequency division multiplexed, reference symbols 51 are not. In other words, the reference symbols of access points A and B are transmitted across the entire system bandwidth of the control region, such that the reference symbols of access point A overlap with the reference symbols of access point B. Hence, despite access point A and access point B being configured to use different control channels (i.e. control channels that occupy different portions of the frequency domain), at least one of the reference symbols transmitted by access point A overlaps with at least one of the reference symbols transmitted by access point B.

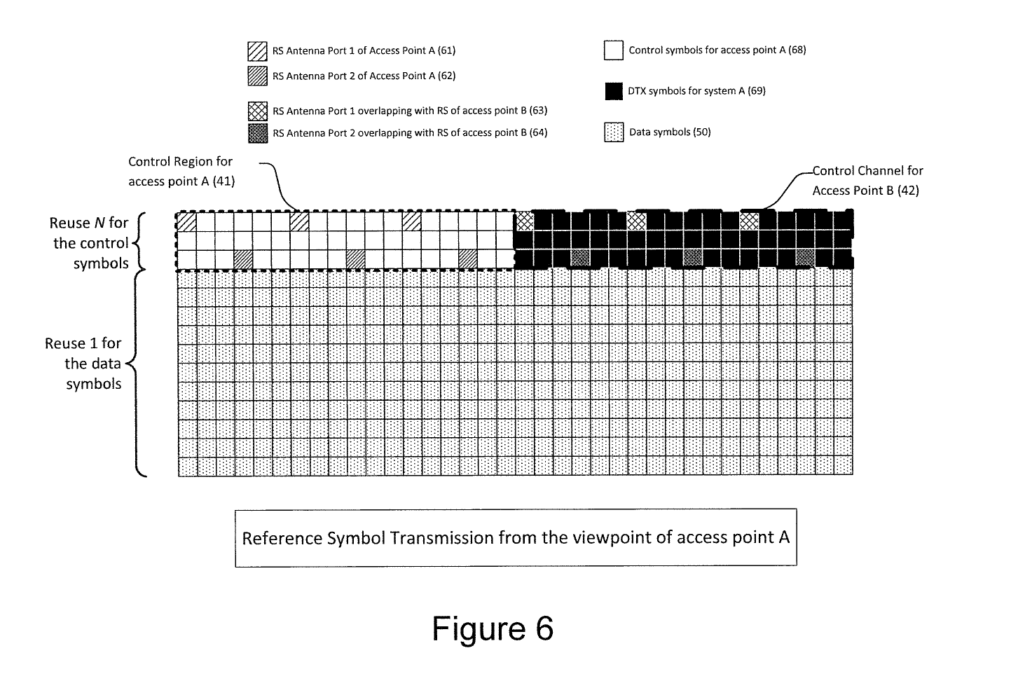

Thus, referring now to FIG. 6, a system frame according to a method, apparatus, and computer program of an example embodiment is illustrated from the perspective of an apparatus 20 that may be embodied by or otherwise associated with an access point, such as access point 11, in order to cause transmission of the depicted system frame. In this regard, the apparatus 20 may include means, such as the processing circuitry, the processor 22, the memory 24, the communications interface 26 or the like, for causing a first set of one or more reference symbols 61 to be transmitted in at least one control channel of a system frame. The system frame incorporates control channel frequency reuse and comprises a plurality of control channels (41 and 42). As shown in FIG. 6, at least one of the reference symbols 61, 62 transmitted by access point A, such as access point 11, overlap with reference symbols transmitted by access point B, such as access point 12. The overlapping symbols are indicated by cross-hatched squares 63, 64. Furthermore, access point A (11) may also be caused, such as by apparatus 20, to transmit discontinuous reception (DTX) symbols in the control channel of access point B (12). Thus, in one embodiment, the DTX symbols of access point A (11) may overlap with the control symbols for access point B (12).

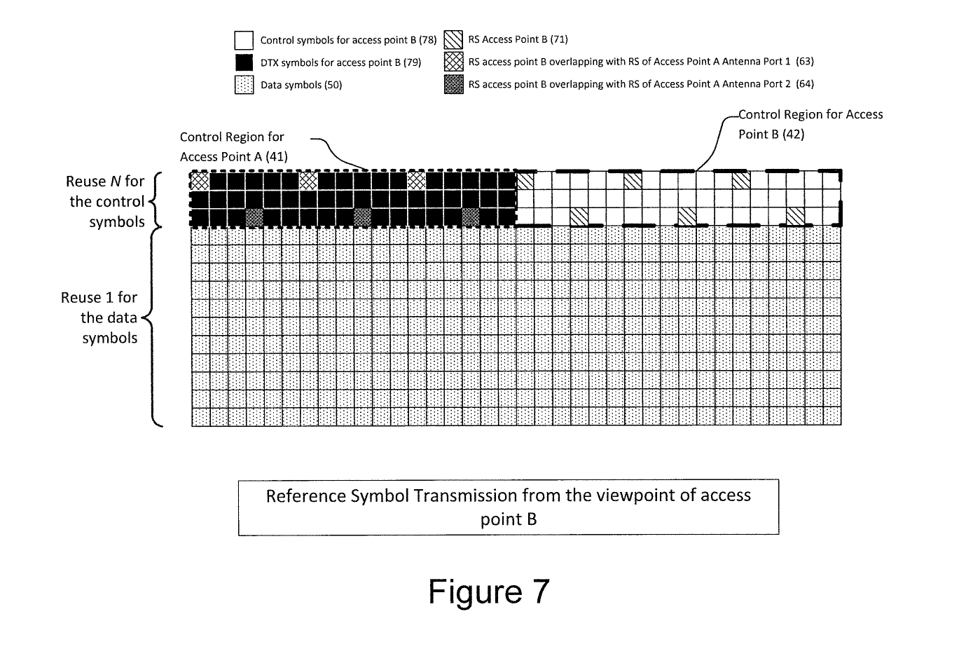

FIG. 7 also shows a system frame according to a method, apparatus, and computer program of an example embodiment, but illustrated from the perspective of an apparatus 20 that may be embodied by or otherwise associated with access point B (12). In this regard, the apparatus 20 may include the same means mentioned above, for causing a set of reference frames 71 to be transmitted in at least one control channel of a system frame incorporating control channel frequency reuse and comprising a plurality of control channels (41 and 42). As shown in FIG. 7, at least one of the reference symbols 71 transmitted by access point B (12) overlap with reference symbols transmitted by access point A (11), indicated by crosshatched squares 63 and 64. Similarly to access point A (11), access point B (12) may also be caused to transmit control symbols 78 within its respective control region 42, and DTX symbols 79 within access point A (11)'s control region 41, such that control symbols 78 transmitted by access point B (12) overlap with DTX symbols 69 transmitted by access point A (11) (see FIG. 6), and vice versa.

Returning now to FIG. 6, a further aspect of an example embodiment will be discussed. In this regard, apparatus 20, embodied by or otherwise associated with an access point, such as access point A (11), may include means such as the processing circuitry, the processor 22, the memory 24, the communications interface 26 or the like, for causing the first set of reference symbols 61 to be transmitted according to a particular configuration. The qualities of the configuration, such as, for example, the placement and density of the reference symbols, may, for example, be based on characteristics of the radio environment. The characteristics of the radio environment may include, for example, a delay spread or a Doppler, e.g., of a communication channel. Access point B (12) may similarly embody or otherwise be associated with an apparatus 20 including the aforementioned means, such that access points A and B can both transmit their respective reference symbols according to respective configurations. These configurations may, according to one embodiment, be changed dynamically, as characteristics or conditions of the radio environment change. Thus, according to an example embodiment, access points can be configured dynamically with alternative reference symbol configurations per access point while maintaining the overlapping configuration for the control region reference symbol locations across the deployment bandwidth.

In addition to the reference symbol configurations being based on radio environments, they may also be based on characteristics of the access points themselves. For example, access point A (11) is depicted in FIG. 6 as being configured with two antenna ports to support MIMO (multiple-in multiple-out) transmission. Compare this with the configuration of access point B (12) as depicted in FIG. 7, which is configured with a single antenna port. Access point B (12) utilizes only one antenna port and uses a more dense reference symbol configuration than each of the looser configuration for each antenna port of access point A (11). Each of access point A (11)'s antenna ports have equally dense reference symbol configurations in frequency domain, each having a reference symbol every Nth subcarrier. On the other hand access point B (12)'s one antenna port uses a configuration in which the reference symbols are more densely placed in the frequency domain, resulting in having a reference symbol every N/2th subcarrier. As depicted in the figures, the reference symbol locations for both systems overlap, although the access point A (11) has a two antenna port reference symbol configuration and access point B (12) has a one antenna port reference symbol configuration.

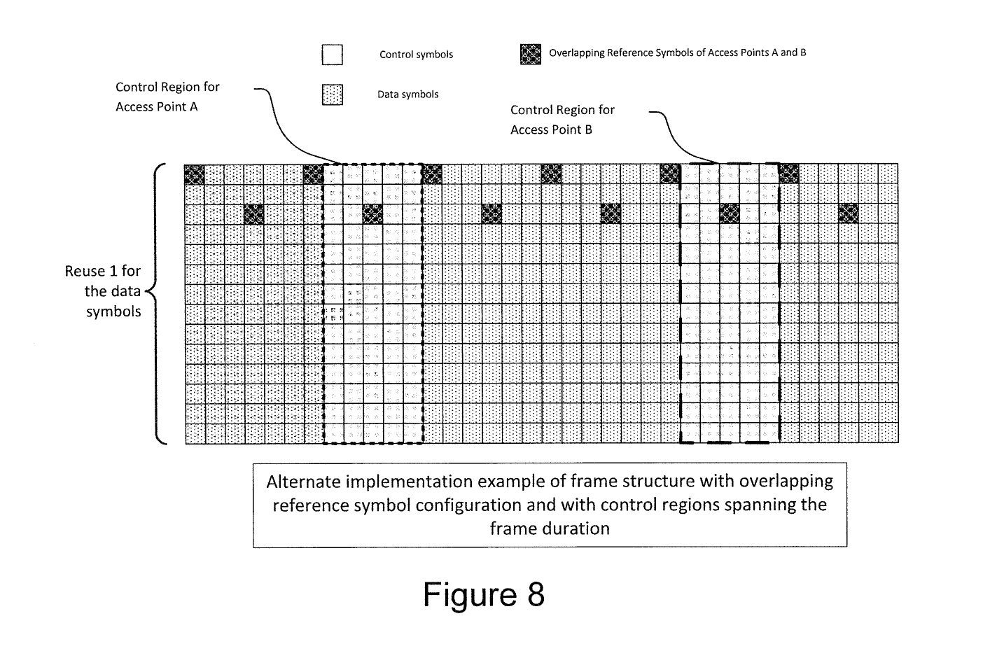

FIG. 8 depicts an even further example configuration of a reference frame according to an embodiment of the present invention. As depicted in FIG. 8, the control region for access points A (11) and B (12) may span the entire time duration of the system frame. Many other possible configurations of a system frame implementing overlapping reference symbols according to embodiments of the present invention are possible.

As discussed above, the reference symbol configuration used by an access point may be based on the number of antenna ports. The reference symbol configuration used by an access point may also be based on other aspects, such as: the radio propagation environment, e.g., the RMS delay spread of a channel associated with the access point; whether the access point supports high/low mobility; or a number of spatial streams of the access point. It should be understood that the reference symbol configuration used by an access point may also be based on any number of other factors or combinations of factors beyond those mentioned above.

According to another embodiment, a minimum configuration may be provided. Thus, according to an embodiment, apparatus 20, embodied by or otherwise associated with an access point, such as access point A (11) or B (12), may include means such as the processing circuitry, the processor 22, the memory 24, the communications interface 26 or the like, for causing the access point to transmit reference symbols according to the minimum configuration by default. The minimum configuration may, for example, involve transmitting reference symbols across the entire system bandwidth as depicted, for example, in FIG. 4. The minimum configuration may, according to one embodiment, be used by all access points in a system, with additional reference symbols being placed in other locations according to additional configurations. The other locations may be, for example, cell-specific locations, such as those depicted in FIG. 3. The additional configurations may include, for example, multi-antenna configurations or UE specific configurations. These additional reference symbols may or may not overlap. Regardless of the additional configuration(s) used the reference symbols in the minimum configuration may always be transmitted to enable cell detection without requiring knowledge about the specific configuration(s) used by the access point or cell.

According to one embodiment, reference symbol configurations may, for example, be signaled or otherwise indicated in system broadcast information. Thus, according to one embodiment, system broadcast information may be decoded using the minimum reference symbol configuration. The system broadcast information may then, for example, be used to discern the additional configurations. For example, in one embodiment, different reference symbol configurations may be predefined and signaled via reference to a configuration index. Thus, a UE may decode the system broadcast information using the minimum reference symbol configuration, detect a configuration index, and use the configuration index to determine one or more additional reference symbol configurations. A change in a reference symbol configuration may also be indicated in the system broadcast information.

According to a further embodiment, apparatus 20, embodied by or otherwise associated with an access point, such as access point A (11) or B (12), may include means such as the processing circuitry, the processor 22, the memory 24, the communications interface 26 or the like, for causing the access point to transmit reference symbols comprising orthogonal sequences in overlapping positions. Transmitting overlapping reference symbols comprising orthogonal sequences may, for example, allow UEs to distinguish the transmissions of different access points or cells.

It should be understood that all of the above may be applied and extrapolated to a communications system of any size. Thus, a system comprising 2, 3, or, indeed, any number of access points may utilize the methods, apparatuses, and computer program products discussed above as embodied by, or otherwise associated with, the access points in order to implement the functionality discussed herein. Thus, a system may, for example, comprise 3 or more access points, all of which transmit reference symbols which overlap.

Furthermore, although all of the above embodiments have been discussed from the perspective of an apparatus 20 associated with an access point, it should be understood that an example embodiment of the present invention may also include corresponding receiving and detecting functionality on the UE side. In this regard, an apparatus 20 associated with a UE, such as UE 10 depicted in FIG. 1, is also provided, which includes means for implementing this corresponding receiving and detecting functionality. Thus, for example, apparatus 20 associated with UE 10 may include means, such as the processing circuitry, the processor 22, the memory 24, the communications interface 26 or the like, for receiving a system frame comprising two or more overlapping reference symbols as discussed above. Apparatus 20 associated with UE 10 may further include means, such as the processing circuitry, the processor 22, the memory 24, the communications interface 26 or the like, for performing cell detection, synchronization, and/or channel estimation functions using the two or more overlapping reference symbols. For example, the UE may detect the one or more cells based on orthogonal sequences contained in the one or more overlapping reference symbols. Furthermore, apparatus 20 associated with UE 10 may include means, such as the processing circuitry, the processor 22, the memory 24, the communications interface 26 or the like, for utilizing a minimum reference symbol configuration to perform cell detection, synchronization, and/or channel estimation functions. Apparatus 20 may also include means, such as the processing circuitry, the processor 22, the memory 24, the communications interface 26 or the like, for utilizing the minimum reference symbol configuration to determine at least one additional reference symbol configuration. The minimum reference symbol configuration may, for example, be used to broadcast system information which signals the at least one additional reference symbol configuration. The broadcast system information may signal the at least one additional reference symbol configuration, with a configuration index, such that apparatus 20 may also include means, such as the processing circuitry, the processor 22, the memory 24, the communications interface 26 or the like, for determining the one or more additional reference symbol configurations based on the configuration index. Apparatus 20 may even further include means, such as the processing circuitry, the processor 22, the memory 24, the communications interface 26 or the like, for determining, such as based on detecting broadcast system information by using a minimum reference symbol configuration, a change in a reference symbol configuration.

Embodiments according to the invention may provide many benefits in a wireless communication system. For example, embodiments according to the invention may provide enhanced reference symbol sequence detection due to overlapping orthogonal sequences. Another advantage that may be provided by embodiments of the invention is that uncertainty in frequency synchronization may be alleviated due to different sequences being transmitted with the same resources. Furthermore, embodiments that provide for overlapping reference symbols for different access points or UEs that are transmitted over the full system bandwidth may allow UEs or access points to obtain channel quality measurements over the full system bandwidth which can be used to reduce the common overhead required for efficient scheduling algorithms, thus improving overall system performance. An even further advantage is that embodiments that provide orthogonal sequences for overlapping reference symbols allow multiple access points or UEs to be detected by the same measurements, thus reducing the overhead required for measurements and decisions related to procedures responsible for cell change, interference mapping and autonomous localization with respect to other access points or UEs. Yet another advantage of embodiments of the present invention is that allowing reference symbols to be broadcast over the full system bandwidth with overlapping between cells or access points may allow system designers to utilize longer sequences as reference sequences. Longer sequences may increase the code diversity (because the number of good codes/sequences typically depends on the used code length) which may improve the properties of the codes. In other words, more degrees of freedom for the system design may be obtained with embodiments of the present invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for use in a first access point, the first access point comprising at least one processor and at least one memory storing program code instruction therein, the at least one memory and program code instructions being configured to, with the at least one processor, cause the apparatus to at least:
cause a first set of one or more reference symbols to be transmitted in at least a first control channel of a system frame by the first access point, the system frame comprising a plurality of control channels and incorporating control channel frequency reuse,
wherein at least one of the reference symbols of the first set overlaps with at least one reference symbol in a second set of one or more reference symbols transmitted by a second access point, the second access point being configured to use a second, different, control channel, the second control channel occupying a different portion of the frequency domain from that occupied by the first control channel.

2. The apparatus of claim 1, wherein the first and second access points share a common data channel.

3. The apparatus of claim 1, wherein the first set of reference symbols comprises at least two reference symbols and further wherein the apparatus is arranged to cause the first set of one or more reference symbols to be transmitted by the first access point by causing at least one of the reference symbols of the first set to be transmitted in the first control channel of the plurality of control channels and causing at least one of the reference symbols of the first set to be transmitted in the second control channel of the plurality of control channels.

4. The apparatus of claim 1, wherein the apparatus is arranged to cause the first set of one or more reference symbols to be transmitted by the first access point by causing the first set of one or more reference symbols to be transmitted by the first access point according to a first configuration; further wherein the second set of one or more reference symbols is transmitted by the second access point according to a second configuration.

5. The apparatus of claim 4, wherein qualities of the first and second configurations are based on one or more radio environment characteristics.

6. The apparatus of claim 5, wherein the one or more radio environment characteristics comprise one or more of a delay spread or a Doppler of an associated channel.

7. The apparatus of claim 4, wherein qualities of the first and second configurations are respectively based on one or more characteristics of the first and second access points.

8. The apparatus of claim 7, wherein the one or more characteristics of the first and second access points comprise an antenna port number.

9. The apparatus of claim 4, wherein the first and second configurations comprise minimum configurations, wherein the apparatus is further arranged to:
cause a third set of one or more reference symbols to be transmitted in the system frame by the first access point according to a third configuration.

10. The apparatus of claim 9, wherein the third configuration comprises a multi-antenna configuration.

11. The apparatus of claim 9, wherein the third configuration dictates that the third set of reference symbols is transmitted in cell-specific locations.

12. The apparatus of claim 9, wherein the third configuration dictates that the third set of reference symbols is transmitted at least in part in a data region.

13. The apparatus of claim 9, wherein the apparatus is further caused to cause information regarding the third configuration to be transmitted in system broadcast information by the first access point.

14. The apparatus of claim 13, wherein the system broadcast information is arranged to be decoded using a minimum reference symbol configuration.

15. The apparatus of claim 13, wherein the system broadcast information comprises a configuration index.

16. The apparatus of claim 13, wherein the apparatus is further arranged to cause information regarding a change in the third configuration to be transmitted by the first access point in the system broadcast information.

17. The apparatus of claim 1, wherein the first and second access points are arranged to transmit overlapping reference symbols comprising respective orthogonal sequences.

18. The apparatus of claim 1, wherein the first and second access points are arranged to transmit over a Long Term Evolution (LTE) or LTE-Advanced (LTE-A) network.

19. A method for use in a first access point, the method comprising:
causing a first set of one or more reference symbols to be transmitted in at least a first control channel of a system frame by the first access point, the system frame comprising a plurality of control channels and incorporating control channel frequency reuse,
wherein at least one of the reference symbols of the first set overlaps with at least one reference symbol in a second set of one or more reference symbols transmitted by a second access point, the second access point being configured to use a second, different, control channel, the second control channel occupying a different portion of the frequency domain from that occupied by the first control channel.

20. A computer program product for use in a first access point comprising a non-transitory computer readable medium storing computer program code portions therein, the computer program code portions being configured to, upon execution, cause an apparatus to at least:
cause a first set of one or more reference symbols to be transmitted in at least a first control channel of a system frame by the first access point, the system frame comprising a plurality of control channels and incorporating control channel frequency reuse,
wherein at least one of the reference symbols of the first set overlaps with at least one reference symbol in a second set of one or more reference symbols transmitted by a second access point, the second access point being configured to use a second, different, control channel, the second control channel occupying a different portion of the frequency domain from that occupied by the first control channel.

21. A system for use in a wireless communication network, the system comprising a first access point and a second access point,
wherein the first access point is arranged to cause a first set of one or more reference symbols to be transmitted in at least a first control channel of a system frame, the system frame comprising a plurality of control channels and incorporating control channel frequency reuse, the second access point being arranged to cause a second set of one or more reference symbols to be transmitted in at least a second, different, control channel of the system frame, the second control channel occupying a different portion of the frequency domain from that occupied by the first control channel, and
wherein at least one of the reference symbols of the first set overlaps with at least one reference symbol of the second set.
